(19) United States
(12) Patent Application Publication
(10) Pub. No.: US 2015/0084512 A1
(43) Pub. Date: Mar. 26, 2015

(54) Three-terminal LED and drive circuit thereof

(71) Applicant: HANGZHOU ZHANSHUN TECHNOLOGY CO., LTD, Hangzhou, Zheijiang (CN)

(72) Inventor: Fangling Lv, Hangzhou (CN)

(21) Appl. No.: 14/399,234

(22) PCT Filed: May 17, 2013
(86) PCT No.: PCT/CN2013/075792

§ 371 Date: Nov. 6, 2014

(30) Foreign Application Priority Data
Jun. 4, 2012 (CN) 201210178950.4
Dec. 31, 2012 (CN) 201210595143.2

(51) Int. Cl. H05B 33/08

(52) U.S. Cl. CPC H05B 33/083; H05B 33/089; H05B 33/0812
USPC 315/122

(57) ABSTRACT

A three-terminal LED and drive circuit thereof. The three-terminal LED (1) has an anode, a cathode and a gate. The three-terminal LED (1) includes a LED group (3) formed by connecting at least one LED in series and a gate circuit (2), the first end (21) of the gate circuit (2) and the anode of the LED group (3) are connected with the anode of the three-terminal LED (1), the second end (22) of the gate circuit (2) and the cathode of the LED group (3) are connected with the cathode of the three-terminal LED (1), the third end (23) of the gate circuit (2) is connected with the gate of the three-terminal LED (1).

### TECHNICAL FIELD

The present invention relates to light emitting diode (LED) and LED drive circuit, and more particularly to a three-terminal LED and drive circuit thereof.

### BACKGROUND OF THE INVENTION

As a new lighting source, LED has many significant advantages, such as high lighting efficiency, long life. Typically, LED has two terminals of anode and cathode, as shown in FIG. 1, and is not flexible enough in application. For example, it is difficult to power LEDs in series directly by DC source: LEDs will be damaged by over current flowing through when the applied voltage is too high; or LEDs cannot be derived normally because the current flowing through is insufficient when the applied voltage is too low. When used in series, all LEDs cannot work properly only if one failed/open and results a lower reliability.

### SUMMARY OF THE INVENTION

To overcome the disadvantages of the prior art, the present invention provided a three-terminal LED, the three-terminal LED has an anode, a cathode and a gate, includes a LED string formed by connecting at least one LED in series and a gate circuit, the first end of gate circuit and the anode of LED string are connected with the anode of the three-terminal LED, the second end of gate circuit and the cathode of the LED string are connected with the cathode of the three-terminal LED, the third end of the gate circuit is connected with the gate of the three-terminal LED; based on N-MOSFET thus called N-type three-terminal LED, the gate circuit includes N-channel MOSFET Q20, diode D20 and resistor R20, the drain of N-channel MOSFET Q20 is connected with the first end of gate circuit, the source of N-channel MOSFET Q20 is connected with the second end of gate circuit, the anode of diode D20 is connected with the third end of gate circuit, the cathode of diode D20 is connected with the gate of N-channel MOSFET Q20, one end of resistor R20 is connected with the cathode of diode D20, and the other end of resistor R20 is connected with the source of N-channel MOSFET Q20; controlled by the gate, the gate circuit of three-terminal LED has three operating states of cut-off, fully conduct and linear respectively; for current flowing from anode to cathode in three-terminal LED: the current flows in the LED string of the three-terminal LED when the gate circuit works in cut-off state; the voltage drop between anode and cathode of the three-terminal LED is minimal and the LED string is bypassed when the gate circuit works in fully conduct state; the resistance between the anode and cathode of the three-terminal LED is variable and the voltage drop is variable accordingly, and equals a variable resistor when the gate circuit works in linear state.

As a preferred embodiment, the N-type three-terminal LED includes diode D21 and Z20 further, that is, N-channel MOSFET Q20, diode D20 and D21, resistor R20 and zener Z20, the drain of N-channel MOSFET Q20 is connected with the first end of gate circuit, the source of N-channel MOSFET Q20 is connected with the second end of gate circuit, the anode of diode D20 is connected with the third end of gate circuit, the cathode of diode D20 is connected with the gate of N-channel MOSFET Q20, one end of resistor R20 is connected with the cathode of diode D20, and the other end of resistor R20 is connected with the source of N-channel MOSFET Q20, the anode of diode D21 is connected with the anode of zener Z20, the cathode of zener Z20 is connected with the drain of N-channel MOSFET Q20, the cathode of diode D21 is connected with the gate of N-channel MOSFET Q20.

As a preferred embodiment, the three-terminal LED is P-type when the gate circuit is based on P-channel MOSFET, controlled by the gate voltage relative to the anode, the gate circuit of P-type three-terminal LED works in states of cut-off, fully conduct and linear respectively; the gate circuit of P-type three-terminal LED includes P-channel MOSFET Q22, diode D20 and resistor R20, the source of P-channel MOSFET Q22 is connected with the first end of gate circuit, the drain of P-channel MOSFET Q22 is connected with the second end of gate circuit, the cathode of diode D20 is connected with the third end of gate circuit, the anode of diode D20 is connected with the gate of P-channel MOSFET Q22, one end of resistor R20 is connected with the anode of diode D20, and the other end of resistor R20 is connected with the source of P-channel MOSFET Q22.

As a preferred embodiment, the gate circuit of P-type three-terminal LED includes diode D21 and Z20 further, that is, P-channel MOSFET Q22, diode D20 and D21, resistor R20 and zener Z20, the source of P-channel MOSFET Q22 is connected with the first end of gate circuit, the drain of P-channel MOSFET Q22 is connected with the second end of gate circuit, the cathode of diode D20 is connected with the third end of gate circuit, the anode of diode D20 is connected with the gate of P-channel MOSFET Q22, one end of resistor R20 is connected with the anode of diode D20, and the other end of resistor R20 is connected with the source of P-channel MOSFET Q22; the cathode of diode D21 is connected with the cathode of zener Z20, the anode of zener Z20 is connected with the drain of P-channel MOSFET Q22, the anode of diode D21 is connected with the gate of P-channel MOSFET Q22.

As a preferred embodiment, at least two N-type three-terminal LEDs with the anode and the cathode connected sequentially and all the gates connected together forms a compound N-type three-terminal LED.

As a preferred embodiment, at least two P-type three-terminal LEDs with the anode and the cathode connected sequentially and all the gates connected together forms a compound P-type three-terminal LED.

As a preferred embodiment, at least two compound N-type three-terminal LEDs with the anode and the cathode connected sequentially and all the gates connected through diode sequentially forms a compound high voltage N-type three-terminal LED.

As a preferred embodiment, at least two compound P-type three-terminal LEDs with the anode and the cathode connected sequentially and all the gates connected through diode sequentially forms a compound high voltage P-type three-terminal LED.

As a preferred embodiment, compound N-type three-terminal LED in series with at last one LED forms a hybrid N-type three-terminal LED.

As a preferred embodiment, compound P-type three-terminal LED in series with at last one LED forms a hybrid P-type three-terminal LED.

As a preferred embodiment, compound high voltage N-type three-terminal LED in series with at last one LED forms a hybrid high voltage N-type three-terminal LED.

As a preferred embodiment, compound high voltage P-type three-terminal LED in series with at last one LED forms a hybrid high voltage P-type three-terminal LED.

The present invention provides the three-terminal LED drive circuit and drive method thereof, characterized in that sensing the current flowing through the three-terminal LED from anode to cathode, adjust the gate voltage of the three-terminal LED accordingly, as a result, the current flowing through the three-terminal LED from anode to cathode is regulated.

As a preferred embodiment, the drive circuit of the present invention includes a DC source, a digital controller and at least one branch, wherein all the branches are connected between the positive terminal and the negative terminal of the DC source, and each branch is formed by minimum of two N-type or P-type three-terminal LEDs with the anode and the cathode connected sequentially and a current sensor via serial connection, the digital control receives the branch current from current sensor, and provides equal number of I/Os connected with the gate of three-terminal LEDs respectively.

As a preferred embodiment, the drive circuit of the present invention includes a DC source and at least one branch, wherein all branches are connected between the positive terminal and the negative terminal of the DC source, and each branch is formed by at least two N-type or one compound N-type or one compound high voltage N-type or one hybrid high voltage N-type three-terminal LED with the anode and the cathode connected sequentially and a current source via serial connection, the current source provides a control end connected with all the gate of three-terminal LEDs.

As a preferred embodiment, the drive circuit of the present invention includes a DC source and at least one branch, all branches parallel with the DC source, wherein each branch includes minimum of two P-type or one compound P-type or compound high voltage P-type or hybrid high voltage P-type three-terminal LEDs in series from anode to cathode, and a current source in series, the current source provides a control end connected with the gate of all three-terminal LEDs.

As a preferred embodiment, the drive circuit of the present invention, wherein the DC source is form AC, rectified through rectifier and filtered through filter, or rectified through rectifier and filtered through valley-filler, and has surge suppression circuit before the rectifier.

As a preferred embodiment, the drive circuit of the present invention, wherein the DC source is solar cell.

As a preferred embodiment, the drive circuit of the present invention, wherein the current source includes N-MOSFET Q90, NPN transistor Q91, diode D90, zener Z90, capacitor C90, resistor R90, resistor R91 and resistor R92, R90 is current sense resistor, one end of resistor R90 is connected with the source of N-MOSFET Q90, the other end of resistor R90 is connected with the output end of current source, the source of N-MOSFET Q90 is also connected with the base of transistor Q91, the emitter of transistor Q91 is connected with the output end of current source, the collector of transistor Q91 is connected with one end of resistor R91, the other one end of resistor R91 is connected with the positive end of DC source, N-MOSFET Q92 and P-MOSFET Q93 are in totem pole connection, both gate of N-MOSFET Q92 and P-MOSFET Q93 are connected with the collector of transistor Q91, the drain of N-MOSFET Q92 is connected with the positive end of DC source, the drain of P-MOSFET Q93 is connected with the output end of current source, both source of N-MOSFET Q92, P-MOSFET Q93 are connected with the control end of current source, the drain of N-MOSFET Q90 is connected with the input end of current source, the gate of N-MOSFET Q90 is connected with control end of current source, resistor R92 and capacitor C90 are in parallel and then in series with diode D90, the anode of diode D90 is connected with the collector of transistor Q91, the other conjunction of resistor R92 and capacitor C90 is connected with the emitter of transistor Q91, the cathode of zener Z90 is connected with the collector of transistor Q91, the anode of zener Z90 is connected with the emitter of transistor Q91.

As a preferred embodiment, the drive circuit of the present invention, wherein the current source includes P-MOSFET Q95, PNP transistor Q94, diode D90, zener Z80, capacitor C90, resistor R90, resistor R91 and resistor R92, R90 is current sense resistor, one end of resistor R90 is connected with the source of P-MOSFET Q95, the other end of resistor R90 is connected with the input end of current source, the source of P-MOSFET Q95 is also connected with the base of transistor Q94, the emitter of transistor Q94 is connected with the input end of current source, the collector of transistor Q91 is connected with one end of resistor R91, the other one end of resistor R91 is connected with the negative end of DC source, N-MOSFET Q92 and P-MOSFET Q93 are in totem pole connection, both gate of N-MOSFET Q92 and P-MOSFET Q93 are connected with the collector of transistor Q94, the drain of N-MOSFET Q92 connected with the positive end of DC source, the drain of P-MOSFET Q93 is connected with the negative end of DC source, both source of N-MOSFET Q92, P-MOSFET Q93 are connected with the control end of current source, the drain of P-MOSFET Q95 is connected with the output end of current source, the gate of P-MOSFET Q95 is connected with control end of current source, resistor R92 and capacitor C90 are in parallel and then in series with diode D90, the cathode of diode D90 is connected with the collector of transistor Q94, the other conjunction of resistor R92 and capacitor C90 is connected with the emitter of transistor Q94, the cathode of zener Z90 is connected with the emitter of transistor Q94, the anode of zener Z90 is connected with the collector of transistor Q94.

The beneficial of the present invention is that the flexible control of the three-terminal LED work state is possible and can enable the three-terminal LED to work in an state of internal LED bypassed, internal LED light normally or as a zener when the internal LED open, and the drive circuit thereof is very simple, high efficiency, linear operation, no EMI, small size and high reliability.

### BRIEF DESCRIPTION OF THE DRAWINGS

FIG. 1 is a LED schematic diagram in the prior art;

FIG. 2 is a block diagram showing a three-terminal LED of the present invention, therein FIG. 2(A) Schematic diagram, FIG. 2(B) The internal circuit schematic diagram;

FIG. 3 is a block diagram showing a N-type three-terminal LED of the present invention, in which FIG. 3(A) Schematic diagram, FIG. 3(B) The internal circuit schematic diagram;

FIG. 4 is a block diagram showing a P-type three-terminal LED of the present invention, in which FIG. 4(A) Schematic diagram, FIG. 4(B) The internal circuit schematic diagram;

FIG. 5 is a block diagram showing a compound N-type three-terminal LED of the present invention, in which FIG. 5(A) Schematic diagram, FIG. 5(B) The internal circuit schematic diagram;

FIG. 6 is a block diagram showing a compound P-type three-terminal LED of the present invention, in which FIG. 6(A) Schematic diagram, FIG. 6(B) The internal circuit schematic diagram;

FIG. 7 is a block diagram showing a compound high voltage N-type three-terminal LED of the present invention, in which FIG. 7(A) Schematic diagram, FIG. 7(B) The internal circuit schematic diagram;

FIG. 8 is a block diagram showing a compound high voltage P-type three-terminal LED of the present invention, in which FIG. 8(A) Schematic diagram, FIG. 8(B) The internal circuit schematic diagram;

FIG. 9 is a block diagram showing a hybrid N-type three-terminal LED of the present invention, in which FIG. 9(A) Schematic diagram, FIG. 9(B) The internal circuit schematic diagram;

FIG. 10 is a block diagram showing a hybrid high voltage N-type three-terminal LED of the present invention, in which FIG. 10(A) Schematic diagram, FIG. 10(B) The internal circuit schematic diagram;

FIG. 11 is a block diagram showing a hybrid P-type three-terminal LED of the present invention, in which FIG. 11(A) Schematic diagram, FIG. 11(B) The internal circuit schematic diagram;

FIG. 12 is a block diagram showing a hybrid high voltage P-type three-terminal LED of the present invention, in which FIG. 12(A) Schematic diagram, FIG. 12(B) The internal circuit schematic diagram;

FIG. 13 is a schematic diagram of the first form of the gate circuit of N-type three-terminal LED of the present invention;

FIG. 14 is a schematic diagram of the second form of the gate circuit of N-type three-terminal LED of the present invention;

FIG. 15 is a schematic diagram of the first form of the gate circuit of P-type three-terminal LED of the present invention;

FIG. 16 is a schematic diagram of the second form of the gate circuit of P-type three-terminal LED of the present invention;

FIG. 17 is a schematic diagram of the first embodiment of the drive circuit of the present invention;

FIG. 18 is a schematic diagram of the second embodiment of the drive circuit of the present invention;

FIG. 19 is a schematic diagram of the third embodiment of the drive circuit of the present invention;

FIG. 20 is a schematic diagram of the fourth embodiment of the drive circuit of the present invention;

FIG. 21 is a schematic diagram of one form of the current source circuit of the drive circuit of the present invention;

FIG. 22 is a schematic diagram of another form of the current source circuit of the drive circuit of the present invention;

FIG. 22 is a schematic diagram of DC source of the drive circuit of the present invention;

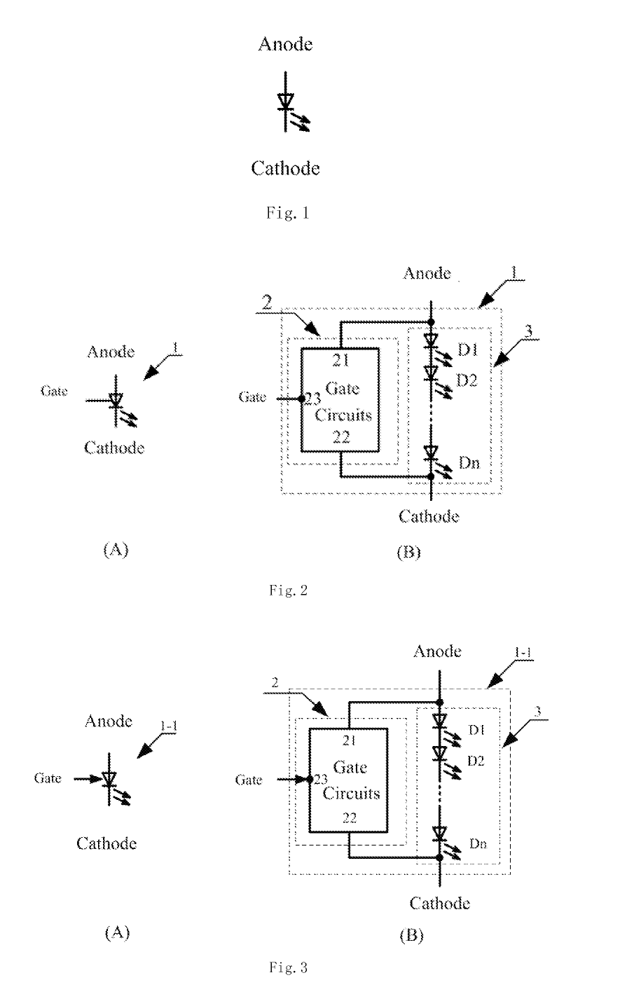

Wherein: 1, three-terminal LED; 2, gate circuit; 21, the first end of the gate circuit; 22, the second end of the gate circuit; 23, the third end of the gate circuit; 3, LED group; 1-1, N-type three-terminal LED; 1-2, P-type three-terminal LED; 1-3, compound N-type three-terminal LED; 1-4, compound P-type three-terminal LED; 1-5, compound high-voltage N-type three LED; 1-6, compound high-voltage P-type three LED; 1-7, hybrid N-type three-terminal LED; 1-8, hybrid high voltage N-type three-terminal LED; 1-9, hybrid P-type three-terminal LED; 1 -10 hybrid high voltage P-type three-terminal LED; 6, digital controller; 7, current sensor; 9-1 one current source; 9-2, another current source; 10, diode; 11, surge suppressor; 12, rectifier; 13, filter; Vin+, the positive terminal of the DC voltage; Vin-, the negative terminal of the DC voltage.

### DETAILED DESCRIPTION OF THE PRESENTLY PREFERRED EMBODIMENTS

With the figures and embodiments, the present invention is described further. The first embodiment of the three-terminal LED: a three-terminal LED with schematic diagram showing as FIG. 3(A), and the internal circuit schematic diagram as FIG. 3(B), includes a LED string 3 formed by connecting at least one LED in series and a gate circuit, and a gate circuit 2, the first end of gate circuit 21 and the anode of LED string are connected with the anode of the three-terminal LED, the second end of gate circuit 22 and the cathode of the LED string are connected with the cathode of the three-terminal LED, the third end of the gate circuit 23 is connected with the gate of the three-terminal LED. The gate circuit showing as FIG. 13, based on N-MOSFET thus called N-type three-terminal LED, includes N-channel MOSFET Q20, diode D20 and resistor R20, the drain of N-channel MOSFET Q20 is connected with the first end of gate circuit, the source of N-channel MOSFET Q20 is connected with the second end of gate circuit, the anode of diode D20 is connected with the third end of gate circuit, the cathode of diode D20 is connected with the gate of N-channel MOSFET Q20, one end of resistor R20 is connected with the cathode of diode D20, and the other end of resistor R20 is connected with the source of N-channel MOSFET Q20.

For current flowing from anode to cathode in three-terminal LED, controlled by the gate voltage relative to the cathode, the gate circuit of three-terminal LED woks in states of cut-off, fully conduct and linear respectively. the current flows in the LED string of the three-terminal LED when the gate circuit works in cut-off state; the voltage drop between anode and cathode of the three-terminal LED is minimal and the LED string is bypassed when the gate circuit works in fully conduct state; the resistance between the anode and cathode of the three-terminal LED is variable and the voltage drop is variable accordingly, and equals a variable resistor when the gate circuit works in linear state. Resistor R20 and diode D20 is to protect the gate-source of MOSFET Q20 from breakdown by reverse voltage.

The second embodiment of the three-terminal LED: a N-type three-terminal LED has a gate circuit showing as FIG. 14, based on N-MOSFET. The gate circuit includes N-channel MOSFET Q20, diode D20 and D21, resistor R20 and zener Z20, the drain of N-channel MOSFET Q20 is connected with the first end of gate circuit, the source of N-channel MOSFET Q20 is connected with the second end of gate circuit, the anode of diode D20 is connected with the third end of gate circuit, the cathode of diode D20 is connected with the gate of N-channel MOSFET Q20, one end of resistor R20 is connected with the cathode of diode D20, and the other end of resistor R20 is connected with the source of N-channel MOSFET Q20, the anode of diode D21 is connected with the anode of zener Z20, the cathode of zener Z20 is connected with the drain of N-channel MOSFET Q20, the cathode of diode D21 is connected with the gate of N-channel MOSFET Q20. Diode D21 and zener Z20 provide OVP: when one LED of the LED group is open, the voltage between the drain and the source of MOSFET Q20 will rise, and will make zener Z20 in breakdown and diode D21 in conduction, the voltage on the gate of MOSFET Q20 will rise relative to the source of MOSFET Q20, and will make the MOSFET Q20 work in linear state, the reliability of the drive circuit will be improved, the threshold of OVP can be increased or set through the breakdown voltage of zener Z20 and the threshold of MOSFET Q20. Zener Z20 can be deleted and the anode of diode D21 is connected to the drain of MOSFET Q20 directly for a minimum Vz on MOSFET Q20. the others circuit configuration and principle are same to the first embodiment.

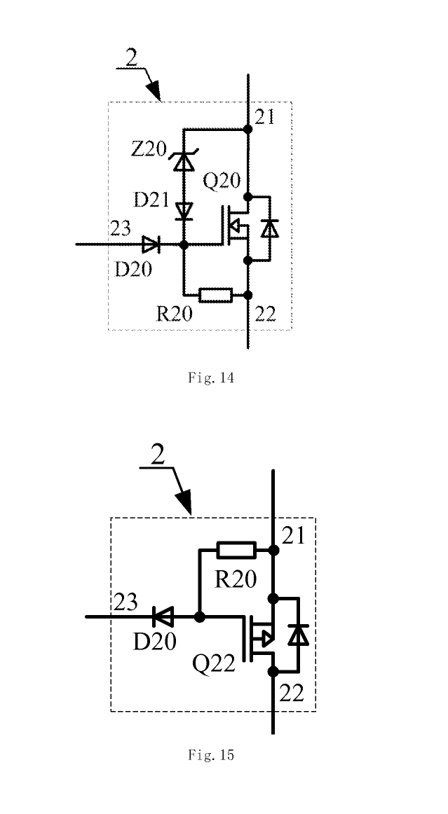

The third embodiment of the three-terminal LED: a three-terminal LED with schematic diagram showing as FIG. 4(A), and the internal circuit schematic diagram as FIG. 4(B), includes a LED string 3 formed by connecting at least one LED in series and a gate circuit, and a gate circuit 2, the first end of gate circuit 21 and the anode of LED string are connected with the anode of the three-terminal LED, the second end of gate circuit 22 and the cathode of the LED string are connected with the cathode of the three-terminal LED, the third end of the gate circuit 23 is connected with the gate of the three-terminal LED. The gate circuit showing as FIG. 15, based on P-MOSFET thus called P-type three-terminal LED. The gate circuit includes P-channel MOSFET Q22, diode D20 and resistor R20, the source of P-channel MOSFET Q22 is connected with the first end of gate circuit, the drain of P-channel MOSFET Q22 is connected with the second end of gate circuit, the cathode of diode D20 is connected with the third end of gate circuit, the anode of diode D20 is connected with the gate of P-channel MOSFET Q22, one end of resistor R20 is connected with the anode of diode D20, and the other end of resistor R20 is connected with the source of P-channel MOSFET Q22.

For current flowing from anode to cathode in three-terminal LED, controlled by the gate voltage relative to the anode, the gate circuit of three-terminal LED woks in states of cut-off, fully conduct and linear respectively.

The fourth embodiment of the three-terminal LED: a P-type three-terminal LED has a gate circuit showing as FIG. 16, based on N-MOSFET. The gate circuit includes P-channel MOSFET Q22, diode D20 and D21, resistor R20 and zener Z20, the source of P-channel MOSFET Q22 is connected with the first end of gate circuit, the drain of P-channel MOSFET Q22 is connected with the second end of gate circuit, the cathode of diode D20 is connected with the third end of gate circuit, the anode of diode D20 is connected with the gate of P-channel MOSFET Q22, one end of resistor R20 is connected with the anode of diode D20, and the other end of resistor R20 is connected with the source of P-channel MOSFET Q22; the cathode of diode D21 is connected with the cathode of zener Z20, the anode of zener Z20 is connected with the drain of P-channel MOSFET Q22, the anode of diode D21 is connected with the gate of P-channel MOSFET Q22; the others circuit configuration and principle are same to the third.

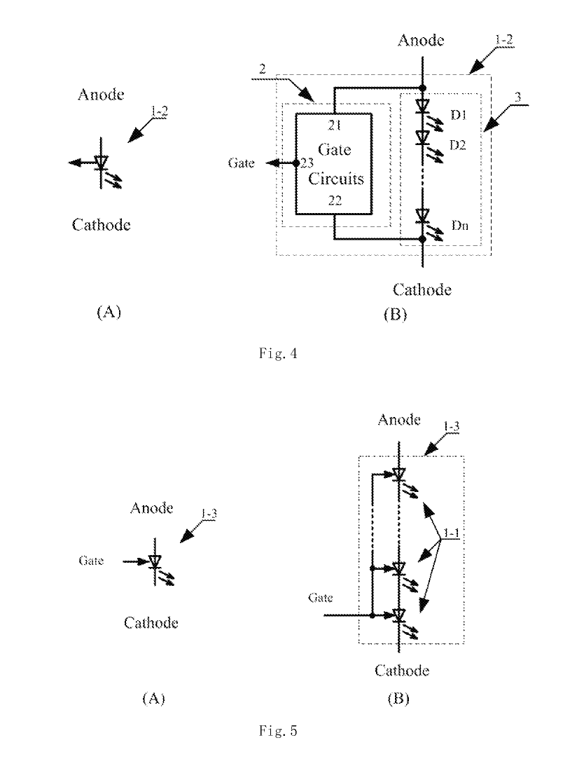

The fifth embodiment of the three-terminal LED: a three-terminal LED with schematic diagram showing as FIG. 5(A), and the internal circuit schematic diagram as FIG. 5(B), includes at least two N-type three-terminal LEDs described in the first and/or the second embodiment, with the anode and the cathode connected sequentially and all the gates connected together, forms a compound N-type three-terminal LED.

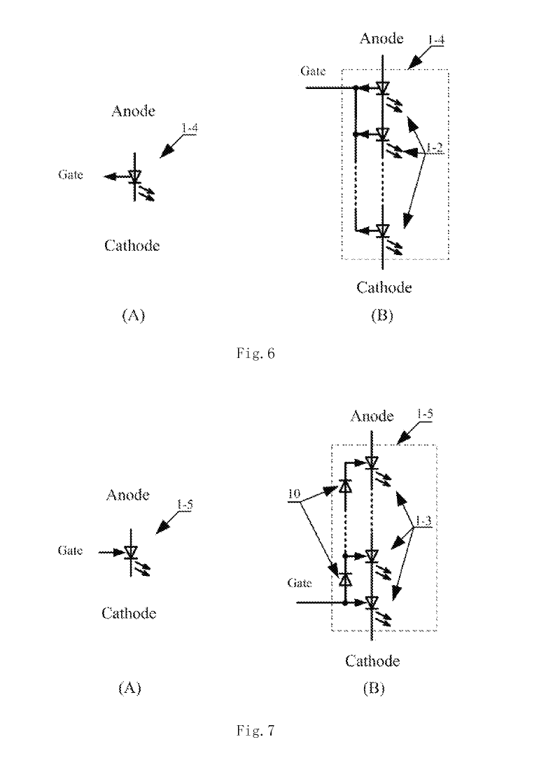

The sixth embodiment of the three-terminal LED: a three-terminal LED with schematic diagram showing as FIG. 6(A), and the internal circuit schematic diagram as FIG. 6(B), includes at least two P-type three-terminal LEDs described in the third and/or the fourth embodiment, with the anode and the cathode connected sequentially and all the gates connected together, forms a compound N-type three-terminal LED.

The seventh embodiment of the three-terminal LED: a three-terminal LED with schematic diagram showing as FIG. 7(A), and the internal circuit schematic diagram as FIG. 7(B), includes at least two compound N-type three-terminal LEDs described in the fifth embodiment, with the anode and the cathode connected sequentially and all the gates connected through diode sequentially, forms a compound high voltage N-type three-terminal LED. By connected through diode sequentially, the voltage endurance from the anode of the three-terminal LED to the gate of the three-terminal LED is increased.

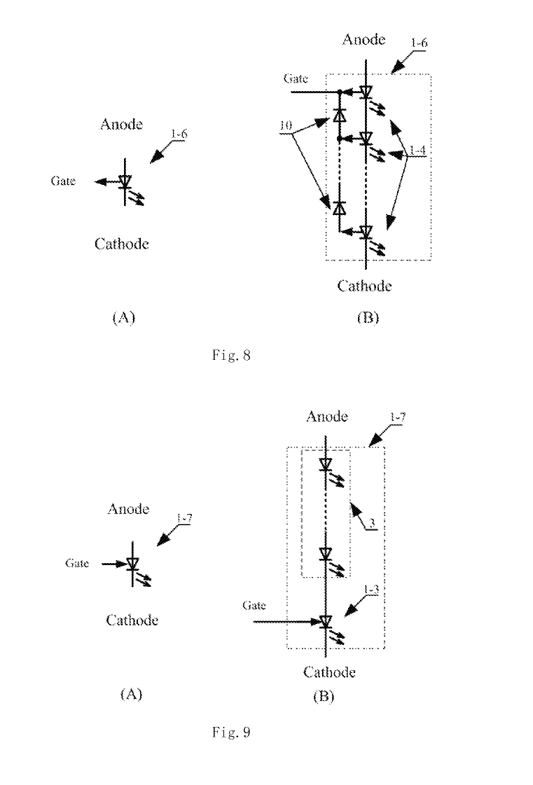

The eighth embodiment of the three-terminal LED: a three-terminal LED with schematic diagram showing as FIG. 8(A), and the internal circuit schematic diagram as FIG. 8(B), includes at least two compound P-type three-terminal LEDs described in the sixth embodiment, with the anode and the cathode connected sequentially and all the gates connected through diode sequentially, forms a compound high voltage P-type three-terminal LED. By connected through diode sequentially, the voltage endurance from the gate of the three-terminal LED to the cathode of the three-terminal LED is increased.

The ninth embodiment of the three-terminal LED: a three-terminal LED with schematic diagram showing as FIG. 9(A), and the internal circuit schematic diagram as FIG. 9(B), includes compound N-type three-terminal LED described in the fifth embodiment in series with at last one LED, forms a hybrid N-type three-terminal LED

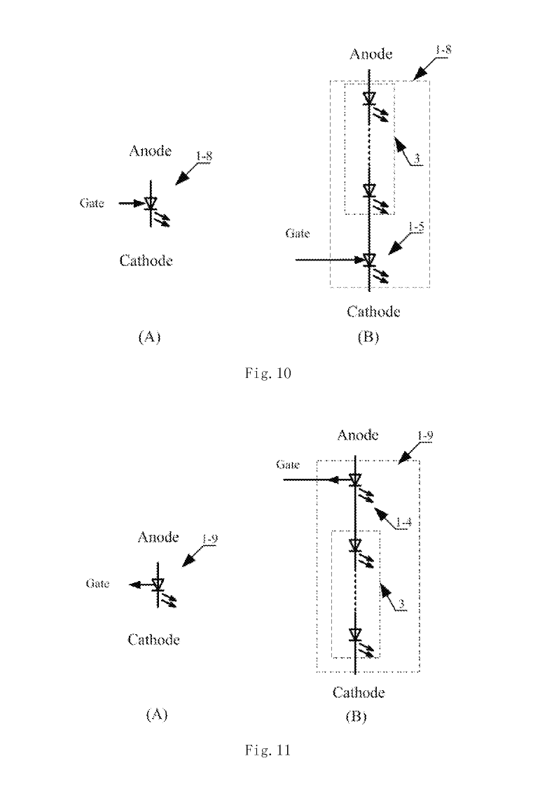

The tenth embodiment of the three-terminal LED: a three-terminal LED with schematic diagram showing as FIG. 10(A), and the internal circuit schematic diagram as FIG. 10(B), includes at least one compound high voltage N-type three-terminal LED described in the fifth embodiment in series with at last one LED, forms a hybrid high voltage N-type three-terminal LED.

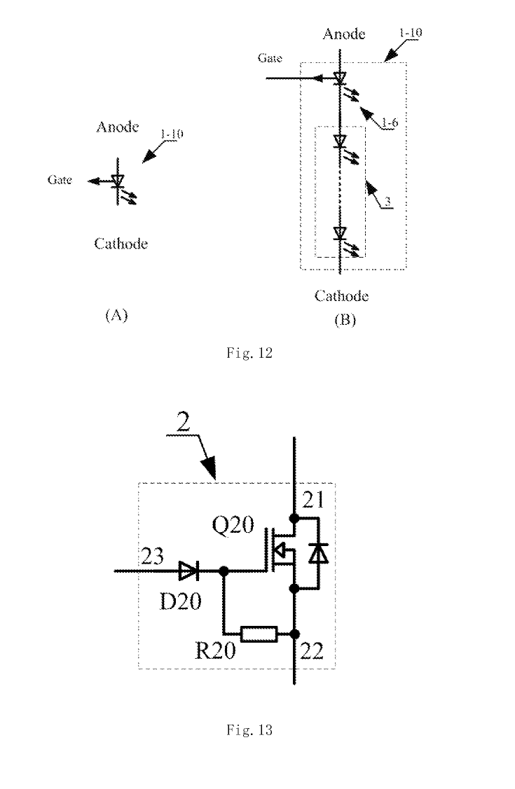

The eleventh embodiment of the three-terminal LED: a three-terminal LED with schematic diagram showing as FIG. 11(A), and the internal circuit schematic diagram as FIG. 11(B), includes compound P-type three-terminal LED described in the sixth embodiment in series with at last one LED, forms a hybrid P-type three-terminal LED.

The twelfth embodiment of the three-terminal LED: a three-terminal LED with schematic diagram showing as FIG. 12(A), and the internal circuit schematic diagram as FIG. 12(B), includes at least one compound high voltage P-type three-terminal LED described in the eighth embodiment in series with at last one LED, forms a hybrid high voltage P-type three-terminal LED.

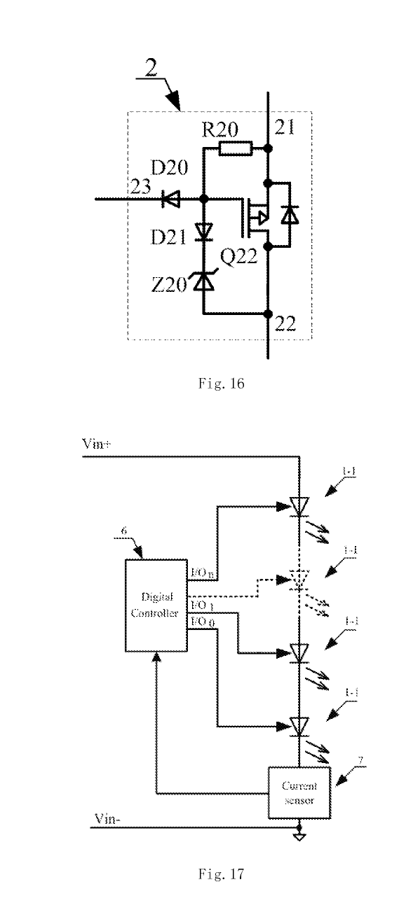

The first embodiment of the drive circuit: the drive circuit of the three-terminal LED with schematic diagram showing as FIG. 17, includes a DC source, a digital controller and one branch, the branch is connected between the positive terminal and the negative terminal of the DC source, and is formed by minimum of two N-type LEDs described in the first embodiment of the three-terminal LED with the anode and the cathode connected sequentially and a current sensor via serial connection, the digital control receives the branch current from current sensor, and provides equal number of I/Os connected with the gate of three-terminal LEDs respectively. The current sensor is formed by a current sense resistor. The digital controller is a MCU.

The digital controller sets all the I/Os controlling the gate of the three-terminal LEDs low after power on, and the series current is minimum, then the digital controller checks the current signal send by current sense resistor, if the current is less than a set value, set the I/Os to high one by one from I/O0 to I/On, and the internal LED group for correspondent three-terminal is shorted, then the series current is increased, and reaches the set value.

When normal working, if the current is less than the set value, one more of the I/Os is set to high from I/O0 to I/On, and the internal LED group for correspondent three-terminal is shorted, then the series current is increased; if the current is more than the set value, one more of the I/Os is set to low from I/On to I/O0, and the internal LED group for correspondent three-terminal light normally, then the series current is decreased.

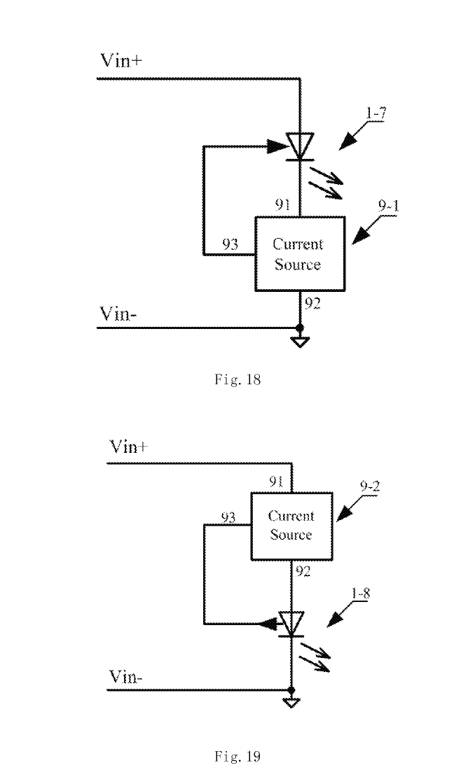

The second embodiment of the drive circuit: the drive circuit of the three-terminal LED with schematic diagram showing as FIG. 18, includes a DC source and one branch, the branch is connected between the positive terminal and the negative terminal of the DC source, and is formed by one hybrid high voltage N-type three-terminal LED described in the tenth embodiment of the three-terminal LED and a current source 9-1 in series. The current source circuit is showing as FIG. 21.

After power on, C80 is charged by Vin+ through R81 and D80, the voltage on the control end of current source increases till the series current reached to a constant value, the constant value of series current is depended on the resistance of current sense resistor R80 and the Vbe of transistor Q81, usually adjusted by the resistance of current sense resistor R80, zener Z80 can restrict the voltage on the drive end of the current source is too high.

When normal working, if the current is less than the set value, the control end of the current source increases, and makes the voltage drop of a three-terminal LED working in a state of linear decrease or more three-terminal LED in a state of internal LED shorted, then the series current is increased; if the current is more than the set value, the control end of the current source decreases, and makes the voltage drop of a three-terminal LED working in a state of linear increase or decrease the number of three-terminal LED in a state of shorted, then the series current is decreased.

When the voltage of DC source is higher than the total forward voltage drop of the internal LED of all three-terminal LEDs, the current source withstands the excess voltage.

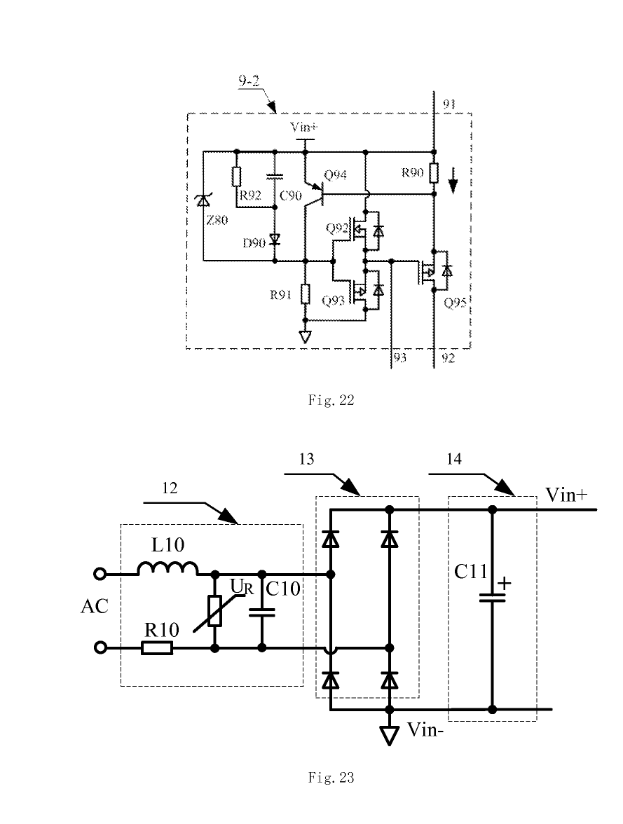

The third embodiment of the drive circuit: the drive circuit of the three-terminal LED with schematic diagram showing as FIG. 19, includes a DC source and one branch, the branch is connected between the positive terminal and the negative terminal of the DC source, and is formed by one hybrid high voltage P-type three-terminal LED described in the twelfth embodiment of the three-terminal LED and a current source 9-2 in series. The current source circuit is showing as FIG.22.

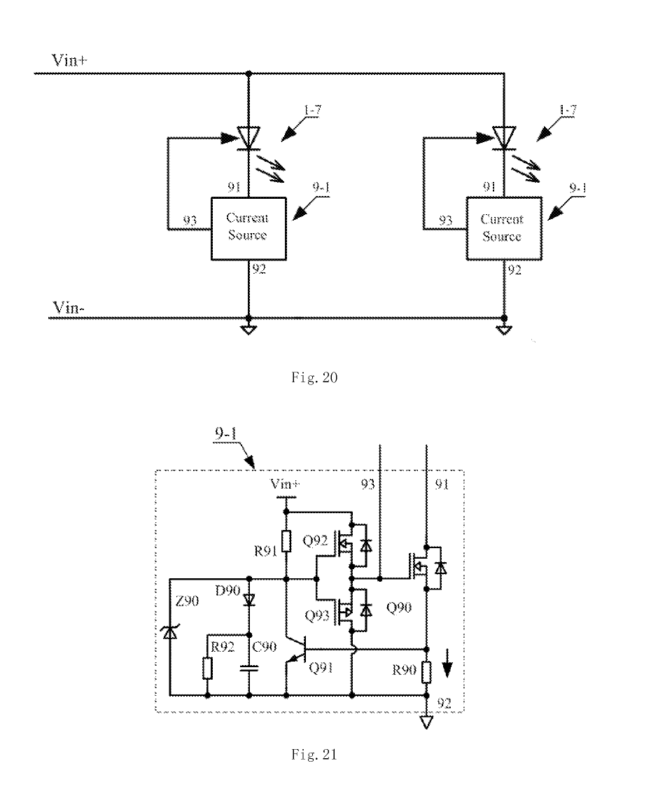

The fourth embodiment of the drive circuit: the drive circuit of the three-terminal LED with schematic diagram showing as FIG. 20, has two branches sharing the DC source in parallel, the branches is formed by one hybrid high voltage N-type three-terminal LED described in the twelfth embodiment of the three-terminal LED and a current source 9-1 in series. The current source circuit is showing as FIG. 21.

The fifth embodiment of the drive circuit: the drive circuit of the three-terminal LED with a schematic diagram of DC source showing as FIG. 22, The DC source is got from 220VAC or 110VAC, through surge suppression circuit 11, rectifier 12 and filter 13, a fuse also can be add in the AC loop. The other others circuit configuration and principle are same to the first embodiment of the driver circuit.

The present invention has been described hereinabove with respect to the exemplary embodiments thereof. It should be appreciated that various modifications, additions and substitutions, such as: using transistor and MOSFET to replace each other; using others current sense way; changing the drive current to achieve the function of dimming; adding the function of OTP; etc., that may be apparent to those having ordinary skill in the pertinent art will falling within the spirit and scope of the present invention.

Although many terminology as linear, short, open, series, parallel and others, are used, but does not exclude possibility of the using others in the present invention. The terminology is used solely to make it easier to describe and illumination the spirit of the present invention, and should not be construed to limit the spirit of the present invention.

1-13. (canceled)

14. A three-terminal LED comprising an anode, a cathode, a gate, and a LED string formed by connecting at least one LED in series and a gate circuit, the first end of gate circuit and the anode of LED string are connected with the anode of the three-terminal LED, the second end of gate circuit and the cathode of the LED string are connected with the cathode of the three-terminal LED, the third end of the gate circuit is connected with the gate of the three-terminal LED; based on N-MOSFET, the gate circuit comprises a N-channel MOSFET (Q20), a diode (D20) and a resistor (R20), the drain of N-channel MOSFET (Q20) is connected with the first end of gate circuit, the source of N-channel MOSFET (Q20) is connected with the second end of gate circuit, the anode of diode (D20) is connected with the third end of gate circuit, the cathode of diode (D20) is connected with the gate of N-channel MOSFET (Q20), one end of resistor (R20) is connected with the cathode of diode (D20), and the other end of resistor (R20) is connected with the source of N-channel MOSFET (Q20); controlled by the gate, the gate circuit of three-terminal LED has three operating states of cut-off, fully conduct and linear respectively; for current flowing from anode to cathode in three-terminal LED: the current flows in the LED string of the three-terminal LED when the gate circuit works in cut-off state; the voltage drop between anode and cathode of the three-terminal LED is minimal and the LED string is bypassed when the gate circuit works in fully conduct state; the resistance between the anode and cathode of the three-terminal LED is variable and the voltage drop is variable accordingly, and equals a variable resistor when the gate circuit works in linear state.

15. The three-terminal LED according to claim 14, wherein the gate circuit further comprise a diode (D21) and a voltage regulator tube (Z20), that is, the gate circuit comprises the N-channel MOSFET (Q20), two diodes (D20 and D21), the resistor (R20) and the zener (Z20), the drain of N-channel MOSFET (Q20) is connected with the first end of the gate circuit, the source of N-channel MOSFET (Q20) is connected with the second end of the gate circuit, the anode of the diode (D20) is connected with the third end of gate circuit, the cathode of the diode (D20) is connected with the gate of N-channel MOSFET (Q20), one end of the resistor (R20) is connected with the cathode of the diode (D20), and the other end of the resistor (R20) is connected with the source of the N-channel MOSFET (Q20), the anode of the diode (D21) is connected with the anode of the zener (Z20), the cathode of the zener (Z20) is connected with the drain of the N-channel MOSFET (Q20), the cathode of the diode (D21) is connected with the gate of the N-channel MOSFET (Q20).

16. The three-terminal LED according to claim 14, wherein the gate circuit is based on a P-type FET, the gate circuit comprise a P-channel MOSFET (Q22), the diode (D20) and the resistor (R20), the source of the P-channel MOSFET (Q22) is connected with the first end of the gate circuit, the drain of the P-channel MOSFET (Q22) is connected with the second end of the gate circuit, the cathode of the diode (D20) is connected with the third end of the gate circuit, the anode of the diode (D20) is connected with the gate of the P-channel MOSFET (Q22), one end of the resistor (R20) is connected with the anode of the diode (D20), and the other end of the resistor (R20) is connected with the source of the P-channel MOSFET (Q22).

17. The three-terminal LED according to claim 16, wherein the gate circuit further comprises the diode (D21) and the voltage regulator tube (Z20), that is, the gate circuit comprise P-channel MOSFET (Q22), the diodes (D20 and D21), the resistor (R20) and the zener (Z20), the source of P-channel MOSFET (Q22) is connected with the first end of the gate circuit, the drain of the P-channel MOSFET (Q22) is connected with the second end of the gate circuit, the cathode of the diode (D20) is connected with the third end of the gate circuit, the anode of the diode (D20) is connected with the gate of the P-channel the MOSFET (Q22), one end of the resistor (R20) is connected with the anode of the diode (D20), and the other end of the resistor (R20) is connected with the source of the P-channel MOSFET (Q22); the cathode of the diode (D21) is connected with the cathode of the zener (Z20), the anode of the zener (Z20) is connected with the drain of the P-channel MOSFET (Q22), the anode of the diode (D21) is connected with the gate of the P-channel MOSFET (Q22).

18. A three-terminal LED comprising at least two three-LEDs of claim 14 with the anode and the cathode connected sequentially and all the gates connected together.

19. A three-terminal LED, characterized in that comprising at least two of the three-LEDs of claim 14 with the anode and the cathode connected sequentially and all the gates connected through diode sequentially.

20. A three-terminal of LED comprising at least one of the three-LEDs of claim 14 with the anode and the cathode connected sequentially and all the gates connected together, in series with at least one LED.

21. A method of driving the three-terminal LED of claim 14 comprising detecting current flowing through the three-terminal LED from the anode to the cathode, adjusting the gate voltage of the three-terminal LED accordingly, as a result, the current flowing through the three-terminal LED from anode to cathode is regulated.

22. A three-terminal LED drive circuit comprising a DC source, a digital controller and at least one branch, all the branches are connected between the positive terminal and the negative terminal of the DC source, wherein the branch comprises at least two three-terminal LEDs of claim 14 with the anode and the cathode connected sequentially and a current sensor in series, the digital control receives the branch current from current sensor, and provides an equal number of three-terminal LED I/O ports, each I/O ports are connected with the gate of the three-terminal LED.

23. A three-terminal LED drive circuit comprising a DC source and at least one branch, all the branches are connected between the positive terminal and the negative terminal of the DC source, wherein the branch comprises at least two three-terminal LEDs of claim 14 with the anode and the cathode connected sequentially and a current source having a input end, a output end and a control end in series, the control end provided by the current source is connected with all the gate of three-terminal LEDs.

24. The three-terminal LED drive circuit of claim 23, wherein the current source comprise a N-MOSFET (Q90), a NPN transistor (Q91), a diode (D90), a zener (Z90), a capacitor (C90), three resistors (R90, R91, and R92), a N-MOSFET (Q92) and a P-MOSFET (Q93), R90 is a current sense resistor, one end of the resistor R90 is connected with the source of the N-MOSFET (Q90), the other end of the resistor (R90) is connected with the output end of current source, the source of the N-MOSFET (Q90) is also connected with the base of the transistor (Q91), the emitter of the transistor (Q91) is connected with the output end of current source, the collector of the transistor (Q91) is connected with one end of the resistor (R91), the other one end of the resistor (R91) is connected with the positive end of DC source, the N-MOSFET (Q92) and P-MOSFET (Q93) are in totem pole connection, both gate of the N-MOSFET (Q92) and P-MOSFET (Q93) are connected with the collector of the transistor (Q91), the drain of the N-MOSFET (Q92) is connected with the positive end of DC source, the drain of the P-MOSFET (Q93) is connected with the output end of current source, both source of the N-MOSFET (Q92), P-MOSFET (Q93) are connected with the control end of current source, the drain of the N-MOSFET (Q90) is connected with the input end of the current source, the gate of the N-MOSFET (Q90) is connected with the control end of the current source, the resistor (R92) and capacitor (C90) are in parallel and then in series with the diode (D90), the anode of the diode (D90) is connected with the collector of the transistor (Q91), the other conjunction of the resistor (R92) and the capacitor (C90) is connected with the emitter of the transistor (Q91), the cathode of the zener (Z90) is connected with the collector of the transistor (Q91), the anode of the zener (Z90) is connected with the emitter of the transistor (Q91).

25. The three-terminal LED drive circuit of claim 23, wherein the current source comprises a P-MOSFET (Q95), a PNP transistor (Q94), a diode (D90), a zener (Z80), capacitor (C90), resistor (R90), resistor (R91), resistor (R92), N-MOSFET (Q92) and P-MOSFET (Q93), R90 is a current sense resistor, one end of the resistor (R90) is connected with the source of P-MOSFET (Q95), the other end of the resistor (R90) is connected with the input end of current source, the source of the P-MOSFET (Q95) is also connected with the base of the transistor (Q94), the emitter of the transistor (Q94) is connected with the input end of the current source, the collector of the transistor (Q91) is connected with one end of the resistor (R91), the other one end of the resistor (R91) is connected with the negative end of DC source, N-MOSFET (Q92) and P-MOSFET (Q93) are in totem pole connection, both gate of N-MOSFET (Q92) and P-MOSFET (Q93) are connected with the collector of the transistor (Q94), the drain of the N-MOSFET (Q92) is connected with the positive end of the DC source, the drain of the P-MOSFET (Q93) is connected with the negative end of the DC source, both sources of N-MOSFET (Q92) and P-MOSFET (Q93) are connected with the control end of current source, the drain of P-MOSFET (Q95) is connected with the output end of current source, the gate of P-MOSFET (Q95) is connected with control end of current source, resistor (R92) and capacitor (C90) are in parallel and then in series with the diode (D90), the cathode of the diode (D90) is connected with the collector of the transistor (Q94), the other conjunction of resistor (R92) and capacitor (C90) is connected with the emitter of transistor (Q94), the cathode of the zener (Z90) is connected with the emitter of transistor (Q94), the anode of the zener (Z90) is connected with the collector of the transistor (Q94).

26. The three-terminal LED drive circuit of claim 22, wherein the DC source is obtained from AC source via a rectifier, a filter, and a surge suppression circuit before the rectifier.
